(19) United States
(12) Patent Application Publication
(10) Pub. No.: US 2007/0241262 A1
(43) Pub. Date: Oct. 18, 2007

(54) Optical sensing unit for an optical input device

(75) Inventor: Yu-Qi Wang, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (TW)

(21) Appl. No.: 11/405,479

(22) Filed: Apr. 18, 2006

(51) Int. Cl. G06M 7/00

(52) U.S. Cl. 250/221

(57) ABSTRACT

An optical sensing unit includes a circuit board on which is situated a first row of light detecting sensors and discrete a second row of light detecting sensors. The first row of light detecting sensors detects changes in light intensity indicative of relative movement along a first axis, and the second row of light detecting sensors detects changes in reflected light intensity indicative of relative movement along a second axis. Therefore, a cursor or content of the display of the computer system will be moved or scrolled accordingly.

### BACKGROUND OF THE INVENTION

1. Field of the Invention

The present invention relates to an optical input device, and in particular to an optical input device having a light detecting unit that does not require costly two-dimensional single or multiple-chip photo detector or image sensor arrays, but rather that uses relatively inexpensive individual rows of sensors to detect changes in a reflected light beam indicative of movement of the input device.

2. Description of the Prior Art

Optical input devices such as the optical mouse or optical trackball are currently widely employed as computer input devices. In such devices, a suitable array (16×16 or 24×24) of photo detectors is located within the housing of the input device for detecting changes in reflected light resulting from movement of the input device across a working surface.

The working principle of the conventional optical input device is that when a light source within the housing projects a light beam on the working surface, the reflected light beam will be detected by the photo sensor and an image frame generated. A micro-processor compares the differences between a previously captured frame and a successive later captured frame, and the movement and the direction of a cursor moving signal will be deduced from difference between the frames and forwarded to a computer system. Input devices that utilize this principle are disclosed in U.S. Pat. Nos. 5,644,139 and 6,433,780.

The photo detectors are typically in the form of complementary metal oxide semiconductor (CMOS) sensors. A disadvantage of the conventional device is the need for precise positioning of the photo detector array on a small chip in order to capture successive frames for comparison, which results in high production costs.

### SUMMARY OF THE INVENTION

It is an object of the present invention to provide an optical sensing unit which is much cheaper in production.

It is another object of the present invention to provide an optical input device which has a much lower cost optical sensing unit.

To accomplish the advantage mentioned above, the optical sensing unit has a circuit board which includes individual first and second rows of light detecting sensors rather than a two-dimensional single-chip detector array.

Those skilled in the art will appreciate that the term “rows” refers to one-dimensional arrays, i.e., arrays that are formed by a l×n array or an array that is one element wide.

### BRIEF DESCRIPTION OF THE DRAWINGS

FIG. 1 is a plan view showing the layout of the present invention.

FIG. 2 is sectional view of the present invention applied to an input device.

FIG. 3 is a plan view showing the layout of the present invention which is placed on a working surface.

FIG. 4 is a schematic diagram showing a coordinate position indicated by the sensing unit of FIG. 3.

FIG. 5 is a schematic diagram showing a change in the coordinate position shown in FIG. 3.

FIG. 6 is a block diagram showing the preferred optical input device coupled to a computer system.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The optical input device of the preferred embodiment includes, but is not limited to, a wired or wireless computer mouse, track ball, game controller, touch pad, or any other device for generating signals to be input to a computer system. The computer system to which the preferred input device is arranged to be connected may be a desktop computer, notebook computer, cell phone, portable device, or any other device arranged to receive signals from an optical input device.

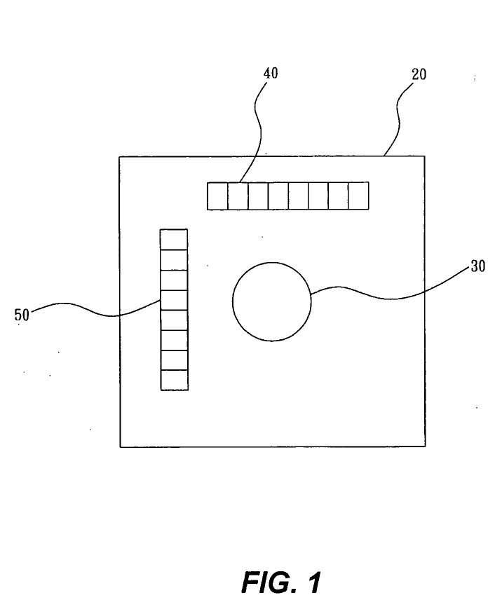

Referring to FIG. 1, a preferred optical sensing unit includes a circuit board 20, a first row of light detecting sensors 40, and a second row of light detecting sensors 50. Both the light detecting sensors 40 and the light detecting sensors 50 are positioned on the circuit board 20. The first row of light detecting sensors 40 can be perpendicular to the second row of light detecting sensors 50, as illustrated by way of example in FIG. 1.

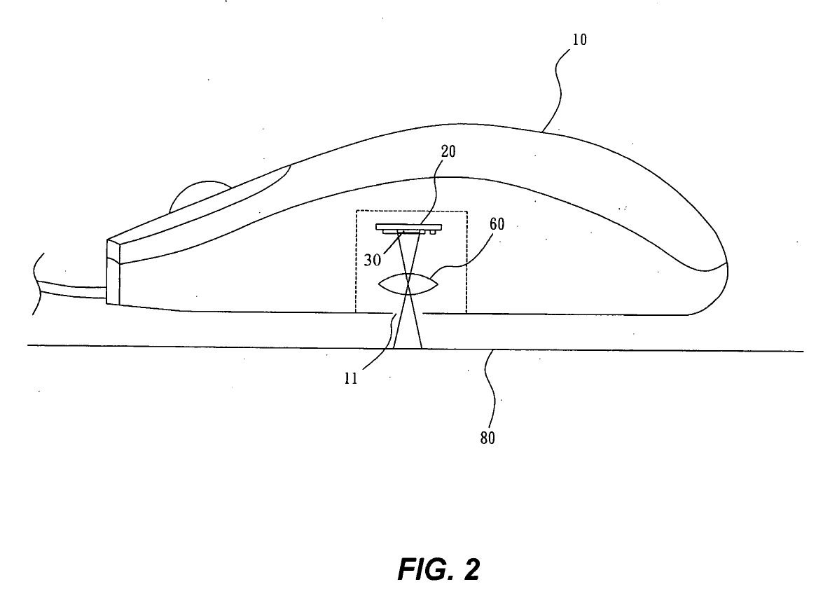

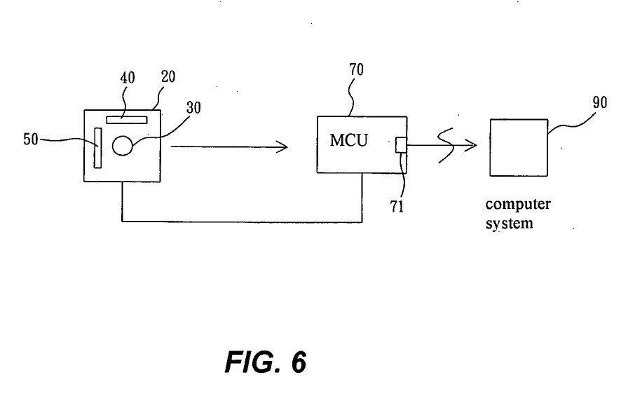

Referring to FIG. 2, an optical input device such as a mouse has a housing 10, and the optical sensing unit is located within the housing 10. A light beam generated by a light source 30 is projected on a working surface 80 through a lens 60 and an opening 11. A reflected light beam from the working surface 80 is received by the optical sensing unit, which detects dark-and-light movement information, i.e., changes in light intensity, captured by the reflected light beam along the X axis and the Y axis. Referring to FIG. 6, a micro control unit (MCU) 70 analyzes the changes in light intensity or dark-and-light movement information, and generates a corresponding cursor moving signal to a computer system 90 via an interface 71.

The first row of light detecting sensors 40 is located on the circuit board 20 along an X axis direction, and the second row of light detecting sensors 50 is located on the circuit board 20 along a Y axis direction. Either or both of the first or the second row of light detecting sensors has a plurality of light sensors. Although the number of sensors may be selected based on a desired sensor resolution and/or other considerations, the present invention arranges, by way of explanation and not limitation, eight light sensors at each axis.

The light source 30 can be a light emitting diode or a laser diode, and can be positioned on the circuit board 20, or near the opening 11.

The lens 60 is positioned between the optical sensing unit and the opening 11 so that the reflected light beam from the working surface 80 can be further focused on the first and second row of light detecting sensors 40 and 50.

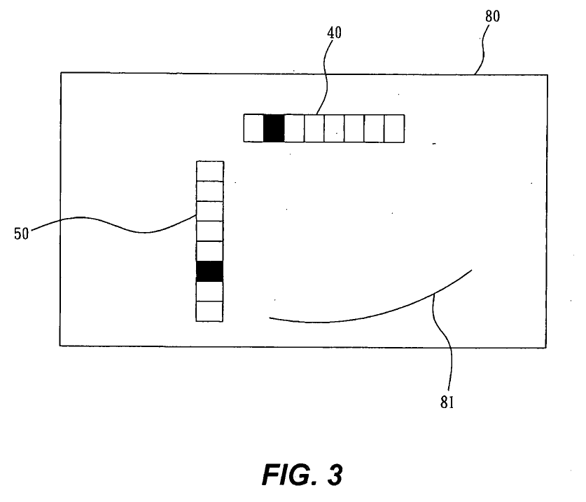

Referring to FIG. 3, because the working surface 80 has a micro texture 80 (uneven surface, spots, strips . . . or the like), once the optical input device is moving on the working surface 80, the first and second row of light detecting sensors 40 and 50 will respectively detect the light-and-dark movement information or changes in reflected light intensity captured by the reflected light beam. Therefore, according to the present invention, the optical input device does not have to make a complicated comparison or calculation as to find out differences between successive image frames.

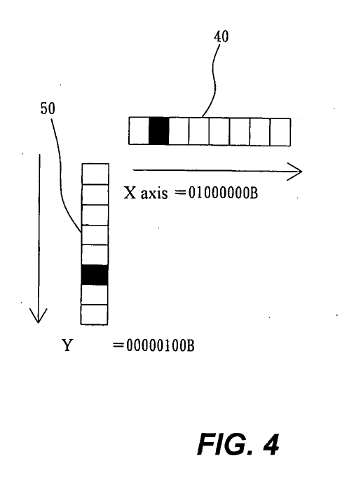

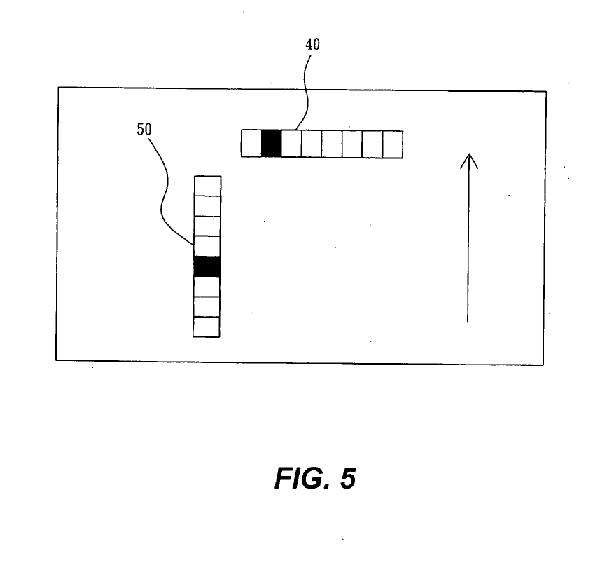

Referring to FIGS. 4 and 5, the first row of light detecting sensors 40 has detected a value at 0100000 and the second row of light detecting sensors 50 has detected a value at 00000100. When the optical input device moves along the Y axis, the second row of light detecting sensors 50 detects a value at 00001000 (the first row of light detecting sensors 40 still keeps the value at 01000000). At this time, the coordinate position of the input device has changed from a first position (01000000, 00000100) to a second position (01000000, 00001000), and the MCU 70 can control a cursor movement on a display along the Y axis accordingly.

When the optical input device moves diagonally, it is understood that the value both at the first and the second row of light detecting sensors 40 and 50 will be changed simultaneously.

According to the invention disclosed above, the optical sensing unit is a coordinate-like detecting device that differs from the frame image comparison system discussed in the U.S. Pat. Nos. 5,644,139 and 6,433,780 in the use of single rows of sensors, as a result of which the maker of the optical input device can greatly reduce costs associated with use of the conventional photo detector array chip(s)l.

Please notice that the present invention can be further applied to scroll the content (left to right or up to down) on a display (not shown) of the computer system 90. U.S. Pat. No. 5,530,455 discloses a similar use of an input device to scroll a Widows application, although not with single rows of detectors. In addition, those skilled in the art may turn the present invention up-side-down and place a transparent plate (not shown) on the opening 11. Once a user moves his finger tip on the plate, the cursor and be moved or the content can be scrolled simultaneously.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. An optical input device coupled to a computer system, comprising:
a housing for accommodating an optical sensing unit;
a micro control unit; and
a light source;
wherein the optical sensing unit further includes a circuit board, a first row of light detecting sensors and a second row of light detecting sensors;
wherein the first row of light detecting sensors detects changes in light intensity reflective of relative movement between the input device and a working surface along a first axis;
wherein the second row of light detecting sensors detects changes in light intensity reflective of relative movement of the input device and a working surface along a second axis; and
wherein the micro control unit within the housing analyzes the changes in light intensity detected by the first and second rows of light detecting such that a cursor on a display of the computer system may be moved accordingly.

2. The input device as claimed in claim 1, wherein the first row of light detecting sensors is perpendicular to the second row of light detecting sensors.

3. The input device as claimed in claim 1, further comprising a lens located at a front side of the optical sensing unit.

4. The input device as claimed in claim 1, wherein the relative movement between the input device and the working surface is a movement of the input device over the working surface.

5. An optical input device coupled to a computer system, comprising:
a housing for accommodating an optical sensing unit;
a micro control unit; and
a light source;
wherein the optical sensing unit further includes a circuit board, a first row of light detecting sensors and a second row of light detecting sensors;
wherein the first row of light detecting sensors detects changes in light intensity reflective of movement of an object over the input device along a first axis;
wherein the second row of light detecting sensors detects changes in light intensity reflective of movement of object relative to the input device along a second axis; and
wherein the micro control unit within the housing analyzes the changes in light intensity detected by the first and second rows of light detecting such that a cursor on a display of the computer system may be moved accordingly.

6. The input device as claimed in claim 5, wherein the first row of light detecting sensors is perpendicular to the second row of light detecting sensors.

7. The input device as claimed in claim 5, further comprising a lens located at a front side of the optical sensing unit.

8. The input device as claimed in claim 7, wherein the object is a user's finger.

9. An optical input device coupled to a computer system, comprising:
a housing for accommodating an optical sensing unit;
a micro control unit; and
a light source;
wherein the optical sensing unit further includes a circuit board, a first row of light detecting sensors and a second row of light detecting sensors;
wherein the first row of light detecting sensors detects changes in light intensity reflective of movement of an object over the input device along a first axis;
wherein the second row of light detecting sensors detects changes in light intensity reflective of movement of object relative to the input device along a second axis; and
wherein the micro control unit within the housing analyzes the changes in light intensity detected by the first and second rows of light detecting such that content of a display on the computer system may be scrolled accordingly.

10. The input device as claimed in claim 9, wherein the first row of light detecting sensors is perpendicular to the second row of light detecting sensors.

11. The input device as claimed in claim 9, wherein the object is a user's finger.

12. An optical sensing unit, comprising:
a circuit board;
a first row of light detecting sensors situated on the circuit board; and
a second row of light detecting sensors situated on the circuit board apart from the first row of light detecting sensors;
wherein the first row of light detecting sensors detects changes in reflected light intensity indicative of relative movement along a first axis; and
wherein the second row of light detecting sensors detects changes in reflected light intensity indicative of relative movement along a second axis.

13. The input device as claimed in claim 9, wherein the first row of light detecting sensors is perpendicular to the second row of light detecting sensors.
